(19) United States
(12) Patent Application Publication
(10) Pub. No.: US 2018/0003198 A1
(43) Pub. Date: Jan. 4, 2018

(54) ROTARY ACTUATOR

(71) Applicant: LB Bentley Limited, Stroud (GB)

(72) Inventor: Krzysztof Jurczyk, Stroud (UK)

(21) Appl. No.: 15/543,489

(22) PCT Filed: Dec. 4, 2015
(86) PCT No.: PCT/GB2015/053715

§ 371 Date: Jul. 13, 2017

(30) Foreign Application Priority Data
Jan. 14, 2015 (GB) 1500575.4

(51) Int. Cl. F15B 15/06; F16K 31/122; F16H 25/18; F16K 31/163; F15B 15/28

(52) U.S. Cl. CPC F15B 15/068; F16K 31/1635; F15B 15/28; F16H 25/18; F16K 31/1221

(57) ABSTRACT

An actuator comprising a housing, a piston driven member axially movable within the housing and being coupled to the housing by a first pin and ramp coupling such that axial movement of the piston driven member relative to the housing is accompanied by angular movement of the piston driven member relative to the housing. The actuator includes an output member constrained against axial movement relative to the housing and coupled to the piston driven member by a second pin and ramp coupling such that both axial and angular movement of the piston driven member drive the output member for angular movement relative to the housing.

### BACKGROUND OF THE INVENTION

### 1. Field of the Invention

This invention relates to an actuator for a valve, and in particular to a hydraulic or pneumatic actuator suitable for use in controlling the operation of a rotary valve.

### 2. Description of Related Art

Rotary valves are in widespread usage and are often employed in applications in which the valve is located at a position in which it is desirable for it to be controlled remotely. By way of example, it may be installed in a subsea environment. Where the position of such a valve requires adjustment relatively frequently, then it is desirable to provide an actuator capable of driving the valve for movement, rather than having to make use of a diver or remotely operated vehicle to make frequent adjustments to the valve. Conveniently, such control is achieved hydraulically or pneumatically.

One known form of actuator suitable for use in such applications includes a piston slidable within a cylinder under the control of the fluid pressure applied thereto. By way of example, the piston may be spring biased towards one end of the cylinder, being movable away from that end of the cylinder when the fluid pressure applied to that end of the cylinder is sufficiently great that a force is applied to the piston overcoming the force applied by the spring. When a lower pressure is applied, the spring biasing results in the piston returning to its original position.

In order to convert such axial movement of the piston to rotary motion, the piston may be guided in such a manner that it is not permitted to undertake rotary or angular movement relative to the cylinder, and may be connected to an angularly moveable output member by a connection including a projection, for example associated with the piston, located within a helical groove, for example associated with the output member, ie by a pin and ramp coupling.

Whilst such an arrangement may be used to achieve angular motion of the output member, to achieve movement of the output member through a desired angle may require the piston stroke to be excessively large, or may require the use of a helical groove of pitch requiring a very large force to be applied by the piston to achieve the required angular motion. As a result, the actuator may need to be of undesirably large dimensions.

### SUMMARY OF THE INVENTION

It is an object of the invention to provide an actuator in which at least some of the disadvantages associated with known arrangements are overcome or are of reduced effect.

According to a first aspect of the invention there is provided an actuator comprising a housing, piston driven member axially movable within the housing and being coupled to the housing by a first pin and ramp coupling such that axial movement of the piston driven member relative to the housing is accompanied by angular movement of the piston driven member relative to the housing, and an output member constrained against axial movement relative to the housing and coupled to the piston driven member by a second pin and ramp coupling such that both axial and angular movement of the piston driven member drive the output member for angular movement relative to the housing.

In use, axial movement of the piston driven member results in angular movement thereof by virtue of the operation of the first pin and ramp coupling which is transmitted to the output member by way of the second pin and ramp coupling. Furthermore, the second pin and ramp coupling converts the axial movement of the piston driven member to additional angular movement of the output member. Accordingly, a desired angular movement of the output member may be achieved through the movement of the piston driven member through only a relatively short stroke. The actuator can thus be of relatively small dimensions.

The first pin and ramp coupling conveniently comprises a pin associated with one of the piston driven member and the housing cooperable within a helical or part helical formation associated with the other of the piston driven member and the housing. Conveniently, the pin is provided on the housing and the helical formation is provided on the piston driven member. The helical formation conveniently comprises a helical groove or slot formed in the piston driven member.

Likewise, the second pin and ramp coupling conveniently comprises a pin associated with one of the piston driven member and the output member cooperable within a helical or part helical formation associated with the other of the piston driven member and the output member. Conveniently, the pin is provided on the output member and the helical formation is provided on the piston driven member. The helical formation conveniently comprises a helical groove or slot formed in the piston driven member.

The helical formations of the first and second pin and ramp couplings are preferably oppositely orientated.

Conveniently each pin and ramp coupling comprises a pair of pins. Each pin preferably carries a rotatable roller.

The piston driven member is conveniently spring biased to a first position. A piston is preferably provided and arranged to apply a load to the piston driven member, when fluid under pressure is applied thereto, to drive the piston driven member for movement against the action of the spring biasing.

The actuator is preferably arranged to drive the gate valve member of a gate valve for angular movement. In such an arrangement, the output member of the actuator is preferably arranged to be driven through an angle of approximately 90° .

It is desirable for actuators associated with rotary valves to incorporate a manual override mechanism whereby the valve can be adjusted, for example manually or using a remotely operated vehicle or the like, in the event that the actuator or associated control system has failed. Where such a mechanism is provided, it is desirable to be able to provide an indication of the position or status of the valve, and to provide an indication regarding whether or not the manual override mechanism is engaged, such indications being useful to an operator controlling the operation of the valve in the event that the actuator has failed.

It is another object of the invention, therefore, to provide an actuator including a manual override mechanism of relatively simple and convenient form.

According to a second aspect of the invention there is provided an actuator comprising an output member couplable by way of a first axially moveable clutch member with a drive transmission member, a cam member engageable with the first clutch member, an input cooperable with the cam member such that an initial angular movement of the input drives the cam member and first clutch member for axial movement to disengage the output member from the drive transmission member, subsequent movement of the input engaging a second clutch so as to permit further angular movement of the input and cam member to drive the transmission member for angular movement.

Preferably, the actuator further comprises guide means operable such that when the cam member is undertaking angular movement, axial movement thereof is resisted, and when the cam member is undertaking axial movement, angular movement thereof is not permitted.

The guide means conveniently takes the form of a pin carried by a housing, the pin having a part cooperating with a formation provided on the cam member. The formation preferably comprises a flat bottomed, U-shaped slot.

The output member may comprise the output member of an actuator in accordance with the first aspect of the invention.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIGS. 1 and 2 are sectional views illustrating a valve and an associated actuator in accordance with an embodiment of the invention.

FIGS. 3 and 4 are exploded views illustrating parts of the actuator of FIGS. 1 and 2.

FIG. 5 is a view illustrating the actuator in a different operating position.

### DESCRIPTION OF THE PREFERRED EMBODIMENT(S)

Referring to the accompanying drawings, a valve actuator 10 is illustrated, the actuator 10 being intended for use in driving a rotary valve 12 for movement between open and closed positions. The rotary valve 12 comprises a valve body 14 connected to a stem 16 that is angularly movable to drive the valve body 14 for angular movement between open and closed positions. The precise nature of the valve 12 is not of relevance to the invention and so the valve 12 will not be described herein in further detail.

The actuator 10 comprises a multi-part housing 18 defining a cylinder 20 within which a piston 22 is moveable under the influence the fluid pressure within a chamber 24 defined between the piston 22 and the cylinder 20. A spring 25 is engageable with a damper than transmits a load to the piston 22 countering that applied by the fluid pressure within the chamber 24. The damper is conveniently provided with a small orifice through which fluid can pass at a restricted rate to damp movement of the damper, and hence of the piston 22.

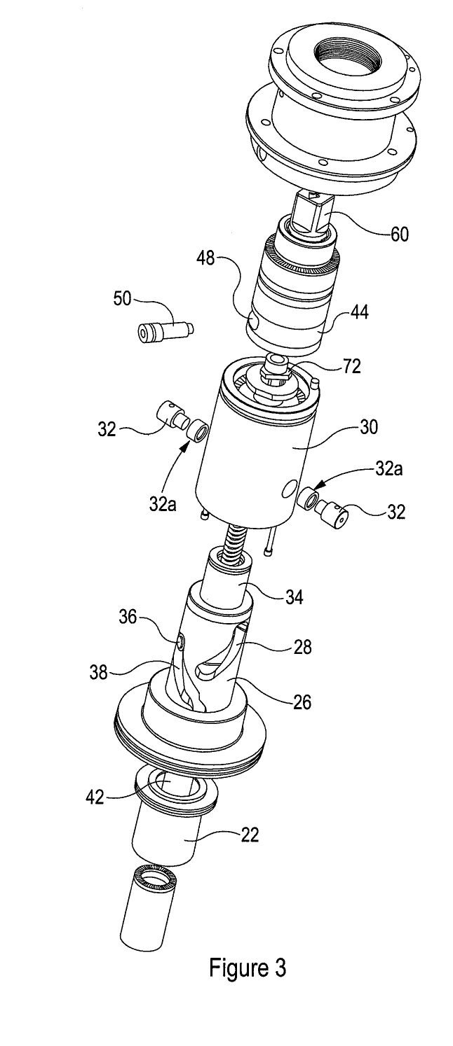

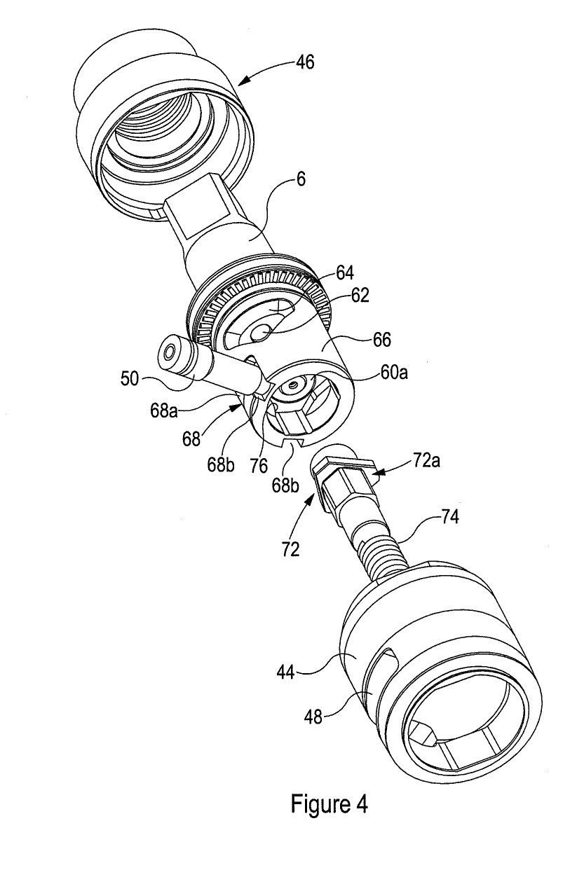

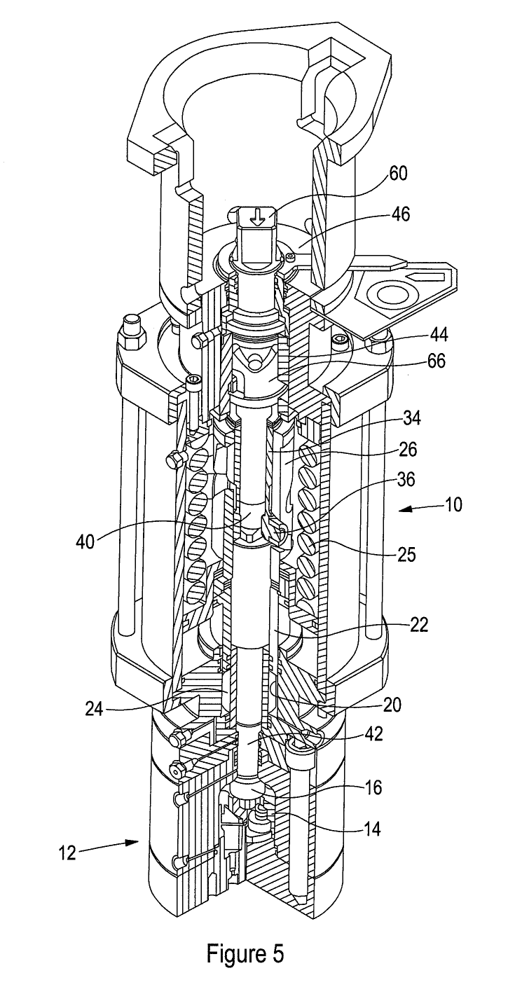

The piston 22 is of multi-part construction, and connected to the piston 22 is a piston driven member 26. The piston driven member 26 is of generally cylindrical form and is slidable within a bore or passage formed in a housing part 30 rigidly connected to and forming part of the housing 18. The piston driven member 26 has a first pair of slots 28 of generally part helical form formed therein. Pins 32 mounted to the housing part 30 project into the first pair of slots 28. As a result, axial movement of the piston driven member 26 occurring as a result of movement of the piston 22 is accompanied by angular movement of the piston driven member 26 relative to the housing part 30. As shown in FIG. 3, the pins 32 conveniently include rotatable rollers 32a, the rollers 32a being located within the slots 28, thereby reducing resistance to movement of the piston driven member 26.

The piston driven member 26 is of hollow tubular form and an output member 34 extends therein. The output member 34 is provided with a pair of pins 36 of form similar to the pins 32, the outer ends of which are received within a second pair of generally helical slots 38 provided in the piston driven member 26. The output member 34 is constrained against axial movement, but is free to rotate. It will be appreciated that axial movement of the piston driven member 26 drives the output member 34 for angular movement relative to the housing 18.

It will be appreciated that the cooperation of the pins 32 within the first slots 28 constitute a first pin and ramp coupling between the housing part 30 and the piston driven member 26, and that the cooperation between the pins 36 and the second slots 38 constitutes a second pin and ramp coupling between the piston driven member 26 and the output member 34.

The output member 34 is coupled by way of a first clutch member 40 to a transmission member 42 in turn coupled to the stem 16. In normal use, with the first clutch member 40 engaged, the application of fluid under pressure to the chamber 24 drives the piston 22 for movement in the upward direction, in the orientation illustrated, against the action of the spring 25. The movement of the piston 22 is accompanied by axial movement of the piston driven member 26. The action of the first pin and ramp coupling serves to ensure that the axial movement of the piston driven member 26 is accompanied by angular movement thereof.

In use, the axial movement of the piston driven member 26 results in angular movement of the output member 34 and the transmission member 42 and stem 16 as a result of the operation of the second pin and ramp coupling. It will be appreciated that the angular movement of the output member 34 stems not only from the axial movement of the piston driven member 26 cooperating via the second pin and ramp coupling to drive the output member 34 for angular movement, but also from the fact that the piston driven member 26 is itself undergoing angular movement as a result of the operation of the first pin and ramp coupling, this angular movement being transmitted to the output member 34 via the second pin and ramp coupling. Accordingly, a relatively large amount of angular movement of the output member 34 may be achieved through the movement of the piston 22 through only a relativelymall axial distance. The actuator 10 can thus be of good compactness.

As shown in FIG. 3, in order to achieve this effect, the first pair of helical slots 28 and the second pair of helical slots 38 extend in opposite orientations. To aid assembly, certain of the slots 28, 30 may include extensions that extend to an end of the piston driven member 26. The extensions need not be of helical form.

As illustrated, the first clutch member 40 includes a region of generally square cross-section, cooperable with correspondingly shaped parts of the output member 34 and transmission member 42. It is desirable for the output member 34 and drive transmission member 42 to only link to one another by the clutch member 40 in one relative angular orientation. To achieve this, the clutch member 40 and corresponding parts of the output member 34 and drive transmission member 42 may not be of truly square cross-section, but rather may include a non-planar, curved face. To aid engagement of the clutch, a shoulder of the clutch member 40 adjacent the generally square cross-section part thereof may be of generally conical form.

The first clutch member 40 extends through the output member 34 and is keyed to an angularly movable stop member 44 that, in turn, is coupled to an indicator 46. In use, the first clutch member 40 is always engaged with the transmission member 42. As a result, the indicator 46 always provides an indication of the angular position of the valve body 14 that is coupled to the transmission member 42. The stop member 44 includes a slot 48 through which a pin 50 mounted upon the housing 18 extends. As the stop member 44 is keyed to and angularly movable with the first clutch member 40, it will be appreciated that the engagement of the pin 50 with the ends of the slot 48 limits the angle through which the valve member 14 can be moved. In the arrangement shown, the length of the slot 48 limits the range of angular movement of the valve member 14 to 90°.

An operator can thus see, from the position of the indicator 46, the angular position of the valve member 14, and will know when the end of its permitted travel is reached as, in addition, the engagement of the pin 50 with the end of the slot 48 will prevent further movement.

The keying of the first clutch member 40 to the stop member 44 is conveniently achieved by providing an end part of the first clutch member 40 with a flange incorporating one or more flats, the flange being received within a correspondingly shaped recess provided in the stop member 44 so as to allow axial movement of the first clutch member 40 relative to the stop member 44 to occur, but to avoid relative angular movement therebetween.

In order to permit manual adjustment of the valve position, for example in the event of a failure of the actuator 10 or associated control arrangement, or for maintenance purposes, a manual override arrangement may be provided. The manual override arrangement may be adapted to allow operation thereof by, for example, a diver or an actuator of a remotely operated vehicle where the valve and actuator are installed in subsea locations. It will be appreciated, however, that the actuator may be used in other locations, and other means may be used to operate the manual override arrangement.

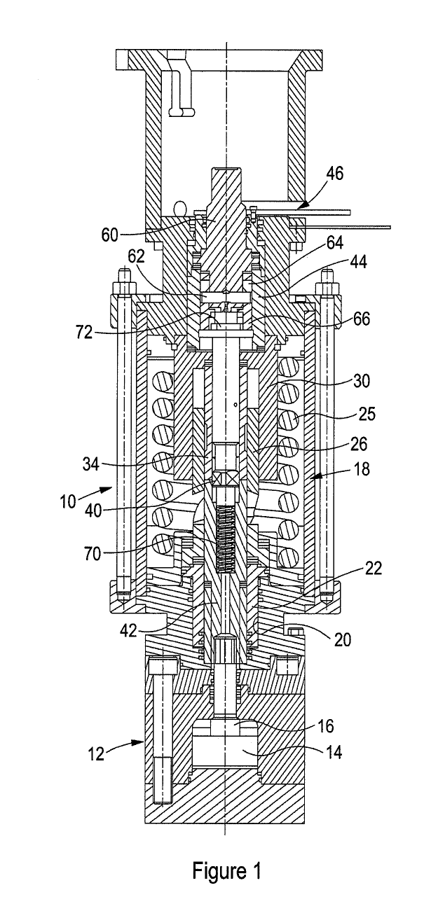

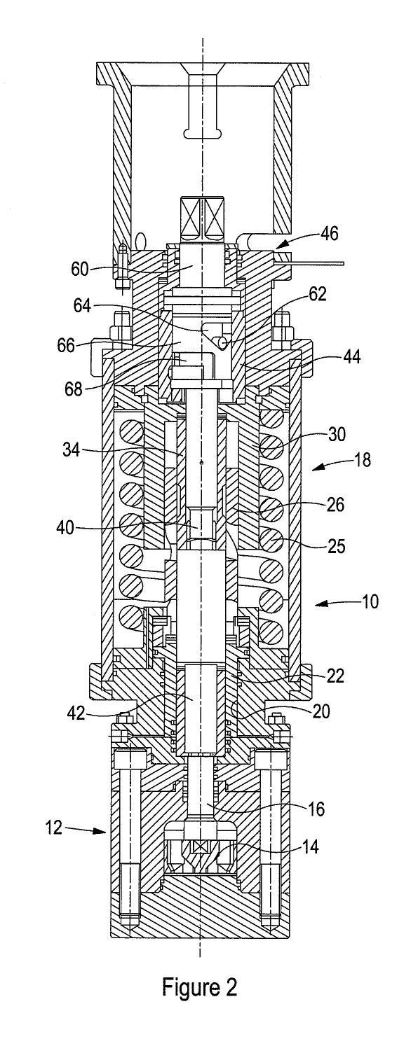

The manual override arrangement comprises an input shaft 60 having an end part shaped to aid manual rotation of the input shaft 60, for example by a diver using a suitable tool or by an actuator of a remotely operated vehicle. In the arrangement shown, the end of the input shaft 60 is of generally square cross-sectional shape, but it will be appreciated that the invention is not restricted in this regard. The input shaft 60 has a drive pin 62 projecting radially therefrom, the drive pin 62 extending into a substantially triangular cam opening 64 formed in a cam member 66 encircling the input shaft 60. It will be understood that angular movement of the input shaft 60 from the position shown in FIGS. 1 and 2 results in the engagement of the pin 62 with the cam opening 64 driving the cam member 66 for axial movement and that, once the pin 62 reaches an apex of the cam opening 64, further movement drives the cam member 66 for angular movement.

The cam member 66 further includes a generally U-shaped guide slot 68 in which an end part of the pin 50 engages, the pin 50 being mounted upon a part of the housing 18 as mentioned hereinbefore. The cam member 66 is engageable with an end of the first clutch member 40 that couples the output member 34 to the transmission member 42. A spring 70 cooperates with the first clutch member 40, urging the first clutch member 40 towards an axial position in which it keys the output member 34 to the transmission member 42 so that they move together, the first clutch being engaged. Displacement of the cam member 66 and first clutch member 40 against the action of the spring 70 disengages the first clutch, the first clutch member 40 remaining in keyed engagement with the transmission member 42.

Keyed to the first clutch member 40 is a second clutch member 72. A spring 74 is located therebetween, the spring 74 urging an end of the second clutch member 72 towards a lower end of the input shaft 60. A thrust bearing 60a is carried by the input shaft 60 and with which the second clutch member 72 is engageable to limit the travel of the second clutch member 72. The second clutch member 72 includes a flange 72a of generally triangular form, and within the cam member 66 there is provided a recess 76 shaped to receive the flange 72a.

In use, when the axial position of the cam member 66 is such that the first clutch member 40 is cooperating with both the output member 34 and the transmission member 42 to transmit drive therebetween, the flange 72a of the second clutch member 72 will be axially spaced from the recess 76. Axial movement of the cam member 66 to drive the first clutch member for disengaging movement results in the recess 76 being moved to a position in which it receives the flange 72a, engaging the second clutch.

The generally U-shaped guide slot 68 is shaped to include a base 68a and a pair of limbs 68b extending parallel to the axis of the cam member 66, the shape of the cam slot 68 being such that when the pin 50 occupies the base 68a, the cam member 66 is able to undergo angular or rotary motion, but axial movement thereof is restricted, and that when the pin 50 occupies one or other of the limbs 68b, the cam member 66 is able to undertake axial movement but not angular or rotary motion.

In normal use, the manual override arrangement will be disengaged, the valve being controlled by controlling the pressure applied to the chamber 24 to control the axial position of the piston 22 and the piston driven member 26, axial movement of the piston 22 being converted to angular movement of the output member 34 and hence in adjustment of the valve position as described hereinbefore. As mentioned hereinbefore, the indicator 46 provides a visible indication of the angular position of the valve member, and the stop function provided by the engagement of the pin 50 within the slot 48 limits the angle through which the valve member 14 can be driven.

In the event that it is desired or required to perform a manual adjustment of the valve then the input member 60 is rotated, for example using an appropriate tool. Angular movement of the input member 60 results in the cam member 66 being driven for axial movement by virtue of the cooperation of the pin 62 carried by the input member 60 with the cam surface 64. During this operation, the pin 50 will occupy one of the limbs 68b, and so angular movement of the cam member 66 will be resisted whilst axial movement thereof is permitted. The axial movement of the cam member 66 is transmitted to the first clutch member 40 resulting in disengaging movement thereof. The spring 74 will maintain the engagement of the end of the second clutch member 72 with the thrust bearing 60a carried by the input shaft 60.

Continued axial movement of the cam member 66 will result in the cam member 66 occupying a position in which the recess 76 receives the flange 72a, engaging the second clutch. The shape of the recess 76 is conveniently such that limited relative angular movement can occur between the flange 72a and the cam member 66, such movement ensuring that the second clutch can become engaged even if there is slight misalignment, and that any applied torques do not inhibit engagement of the second clutch. Further axial movement of the cam member 66 is accompanied by movement of the second clutch member 72. Axial movement of the cam member 66 continues until the pin 62 reaches an apex of the cam surface 64, by which point the pin 50 will occupy an intersection between the limb 68b and the base 68a of the guide slot 68.

The shape of the guide slot 68 is preferably chosen to take into account the above mentioned relative movement. For example, in the arrangement shown the maximum relative movement between the second clutch member 72 and the cam member 66 is 20°. Accordingly, in order to ensure that the valve member can be driven through 90° using the manual override arrangement, the base 68a of the guide slot 68 allows the cam member 66 to be driven through an angle of 110°.

From this position, further angular movement of the input shaft 60 drives the cam member 66 for angular movement, such movement now being permitted by the pin 50 being located within the base 68b of the guide slot 68. The angular movement of the cam member 66 is transmitted via the second clutch and the first clutch member 40 to the transmission shaft 42 and valve member 14. During such movement, the indicator 46 will continue to provide an indication of the angular position of the valve member 14, and the stop member 44 will continue to limit the angle through which the valve member 14 can be moved.

To return the actuator arrangement 10 to a condition in which the valve can be controlled hydraulically or pneumatically, the input shaft 60 is rotated in the reverse direction. If the valve occupies either its fully open or fully closed position then such reverse movement will allow axial movement of the cam member 66, whereon the second clutch will become disengaged and the first clutch will reengage. If the valve occupies an intermediate position, then the cam member 66 will be unable to move axially as the pin 50 will be located within the base 68a of the guide slot 68. Accordingly, the input shaft 60 will need to be moved through an angle sufficient to drive the cam member 66 to move the valve to one of its fully open and fully closed positions before the actuator can be returned to its hydraulic control mode.

It will be appreciated that the actuator arrangement described hereinbefore is advantageous in that it allows the valve member to be driven through a 90° angle whilst being of relatively compact form. A manual override arrangement is provided, and both whilst operating normally and when operated using the manual override, an indicator provides an indication of the valve position.

1. An actuator comprising a housing, a piston driven member axially movable within the housing and being coupled to the housing by a first pin and ramp coupling such that axial movement of the piston driven member relative to the housing is accompanied by angular movement of the piston driven member relative to the housing, and an output member constrained against axial movement relative to the housing and coupled to the piston driven member by a second pin and ramp coupling such that both axial and angular movement of the piston driven member drive the output member for angular movement relative to the housing.

2. An actuator according to claim 1, wherein the first pin and ramp coupling comprises a pin associated with one of the piston driven member and the housing cooperable within a helical or part helical formation associated with the other of the piston driven member and the housing.

3. An actuator according to claim 2, wherein the pin is provided on the housing and the helical formation is provided on the piston driven member.

4. An actuator according to claim 2, wherein the helical formation comprises a helical groove or slot.

5. An actuator according to claim 1, wherein the second pin and ramp coupling comprises a pin associated with one of the piston driven member and the output member cooperable within a helical or part helical formation associated with the other of the piston driven member and the output member.

6. An actuator according to claim 5, wherein the pin is provided on the output member and the helical formation is provided on the piston driven member.

7. An actuator according to claim 5, wherein the helical formation comprises a helical groove or slot.

8. An actuator according to claim 1, wherein the ramps of the pin and ramp couplings are oppositely orientated.

9. An actuator according to claim 1, wherein each pin and ramp coupling comprises a pair of pins.

10. An actuator according to claim 9, wherein each pin carries a rotatable roller.

11. An actuator according to claim 1, wherein the piston driven member is spring biased to a first position.

12. An actuator according to claim 11, wherein a piston is provided and arranged to apply a load to the piston driven member, when fluid under pressure is applied thereto, to drive the piston driven member for movement against the action of the spring biasing.

13. An actuator according to claim 1, wherein the actuator is arranged to drive the gate valve member of a gate valve for angular movement.

14. An actuator comprising an output member couplable by way of a first axially moveable clutch member with a drive transmission member, a cam member engageable with the first clutch member, an input cooperable with the cam member such that an initial angular movement of the input drives the cam member and first clutch member for axial movement to disengage the output member from the drive transmission member, subsequent movement of the input engaging a second clutch so as to permit further angular movement of the input and cam member to drive the transmission member for angular movement.

15. An actuator according to claim 14, further comprising guide means operable such that when the cam member is undertaking angular movement, axial movement thereof is resisted, and when the cam member is undertaking axial movement, angular movement thereof is not permitted.

16. An actuator according to claim 15, wherein the guide means takes the form of a pin carried by a housing, the pin having a part cooperating with a formation provided on the cam member.

17. An actuator according to claim 16, wherein the formation comprises a flat bottomed, U-shaped slot.

18. An actuator according to claim 14, wherein the output member comprises the output member of an actuator comprising a housing, a piston driven member axially movable within the housing and being coupled to the housing by a first pin and ramp coupling such that axial movement of the piston driven member relative to the housing is accompanied by angular movement of the piston driven member relative to the housing, and an output member constrained against axial movement relative to the housing and coupled to the piston driven member by a second pin and ramp coupling such that both axial and angular movement of the piston driven member drive the output member for angular movement relative to the housing.
